(19) United States
(12) Patent Application Publication
(10) Pub. No.: US 2024/0183773 A1
(43) Pub. Date: Jun. 6, 2024

(54) FLOW CYTOMETER

(71) Applicant: ThinkCyte K. K., Tokyo (JP)

(72) Inventors: Keisuke Toda, Tokyo (JP); Toru Imai, Tokyo (JP)

(73) Assignee: ThinkCyte K. K., Tokyo (JP)

(21) Appl. No.: 18/440,156

(22) Filed: Feb. 13, 2024

Related U.S. Application Data
(63) Continuation of application No. PCT/JP22/28167, filed on Jul. 20, 2022.

(30) Foreign Application Priority Data
Sep. 30, 2021 (JP) 2021-161449

(51) Int. Cl. G01N 15/1434; G01N 15/14

(52) U.S. Cl. CPC G01N 15/1434; G01N 15/1484; G01N 2015/144

(57) ABSTRACT

A flow cytometer includes: a microfluidic device; a light source that irradiates illumination light toward an observation object flowing through a flow path; an illumination optical system that shapes the illumination light irradiated by the light source into an illumination light of which a length in a length direction of the flow path is equal to or greater than a length in a width direction of the flow path at an irradiation position of the flow path and irradiates the shaped illumination light; a mask for structured detection that has a binary pattern of transmitting portions and blocking portions; an imaging optical system that images scattered light emitted from the observation object on the mask for structured detection by irradiation of the illumination light shaped by the illumination optical system; and a photodetector that detects the scattered light transmitted through the transmitting portions of the mask for structured detection, wherein a propagation path of direct light, which has been transmitted through the observation object, of the illumination light shaped by the illumination optical system and a propagation path of the scattered light emitted from the observation object until the scattered light is detected by the photodetector are spatially separated from each other by the illumination optical system and the imaging optical system.

Priority is claimed on Japanese Patent Application No. 2021-161449, filed Sep. 30, 2021, the content of which is incorporated herein by reference.

### TECHNICAL FIELD

The present invention relates to a flow cytometer.

### BACKGROUND ART

Means for discriminating or for discriminating and sorting large numbers of cells at a high speed are in strong demand in the fields of regenerative medicine using stem cells such as induced pluripotent stem (iPS) cells, new cancer immunotherapy such as chimeric antigen receptor T (CAR-T) cell therapy, and drug discovery. Flow cytometry is known as such a means. Flow cytometry is a technology of optically analyzing cells by acquiring scattered light and fluorescence generated when specific light is irradiated to the cells while the cells are allowed to flow along a flow path at a constant flow rate.

However, in commonly used flow cytometry, the identification of target cells is often performed on the basis of the detection of fluorescence, which requires labeling using a fluorescent marker. For this reason, it is difficult to use commonly used flow cytometry for the purpose of transplanting or administering analyzed cells to patients, such as in regenerative medicine or CAR-T cell therapy. As a method for optically analyzing information on the cells without labeling with a fluorescent marker (hereinafter also referred to as label-free), for example, there is a method using scattered light (Patent Documents 1 and 2). Scattered light includes forward scatter (FSC), side scatter (SSC), and backward scatter (BSC), depending on the direction of scattering.

### PATENT DOCUMENTS

Japanese Unexamined Patent Application, First Publication No. 2008-032659
Japanese Unexamined Patent Application, First Publication No. H9-079969
PCT International Publication No. WO 2017/073737
PCT International Publication No. WO 2019/241443

### NON-PATENT DOCUMENTS

“Science,” Jun. 15, 2018, Volume 360, No. 6394, p. 1246-1251

### SUMMARY OF INVENTION

### Technical Problem

However, much of information derived from the shape of the cell is missing from the scattered light (FSC, SSC, BSC) acquired in commonly used flow cytometry, and thus it is difficult to discriminate or to discriminate and sort the cells with only the information acquired from the scattered light without any labeling at all.

Ghost cytometry (GC) technology is known as a technology through which more abundant and detailed information derived from the shape of the cell can be acquired than through flow cytometry of the related art (Patent Documents 3 and 4, Non-Patent Document 1). In an optical system for detecting scattered light using ghost cytometry technology, for example, the scattered light emitted from the observation objects is detected through structured detection in which a spatial modulator such as a structured mask pattern is installed in an optical path between a flow path through which the observation objects flow and a detector. In a configuration of the structured detection, a configuration of an illumination optical system that irradiates light to the observation objects passing through the flow path can be simplified, and thus the degree of freedom in device design increases.

There is a need to be able to acquire high-resolution information derived from the shapes of the cells, which cannot be acquired using commonly used flow cytometry, from only scattered light using the configuration of the structured detection.

The present invention has been made in view of the above points, and provides a flow cytometer that can acquire high-resolution information derived from the shape of an observation object only from scattered light using a configuration of structured detection.

### Solution to Problem

According to one aspect of the present disclosure, there is provided a flow cytometer including: a microfluidic device that includes a flow path through which an observation object is allowed to flow together with a fluid; a light source that irradiates illumination light toward the observation object flowing through the flow path; an illumination optical system that shapes the illumination light irradiated by the light source into illumination light of which a length in a length direction of the flow path is equal to or greater than a length in a width direction of the flow path at an irradiation position of the flow path and irradiates the shaped illumination light; a mask for structured detection that has a binary pattern of transmitting portions which transmit light and blocking portions which block light; an imaging optical system that images scattered light emitted from the observation object on the mask for structured detection by irradiation of the illumination light shaped by the illumination optical system; and a photodetector that detects the scattered light transmitted through the transmitting portions of the mask for structured detection, wherein a propagation path of direct light, which has been transmitted through the observation object, of the illumination light shaped by the illumination optical system and a propagation path of the scattered light emitted from the observation object until the scattered light is detected by the photodetector are spatially separated from each other by the illumination optical system and the imaging optical system.

According to one aspect of the present disclosure, there is provided a flow cytometer including: a microfluidic device that includes a flow path through which an observation object is allowed to flow together with a fluid; a light source that irradiates illumination light toward the observation object flowing through the flow path; an illumination optical system that shapes the illumination light irradiated by the light source into illumination light of which a ratio of a length in a length direction of the flow path to a length in a width direction of the flow path is greater than 1/10 at an irradiation position of the flow path and irradiates the shaped illumination light; a mask for structured detection that has a binary pattern of transmitting portions which transmit light and blocking portions which block light; an imaging optical system that images scattered light emitted from the observation object on the mask for structured detection by irradiation of the illumination light shaped by the illumination optical system; and a photodetector that detects the scattered light transmitted through the transmitting portions of the mask for structured detection, wherein a propagation path of direct light, which has been transmitted through the observation object, of the illumination light shaped by the illumination optical system and a propagation path of the scattered light emitted from the observation object until the scattered light is detected by the photodetector are spatially separated from each other by the illumination optical system and the imaging optical system.

Further, according to one aspect of the present disclosure, in the flow cytometer, a lower limit value of the length of the illumination light shaped by the illumination optical system in the length direction of the flow path is 30 micrometers or more, and an upper limit value of the length of the illumination light shaped by the illumination optical system in the length direction of the flow path is 2000 micrometers or less.

Further, according to one aspect of the present disclosure, in the flow cytometer, the lower limit value of the length of the illumination light shaped by the illumination optical system in the length direction of the flow path is 50 micrometers or more.

Further, according to one aspect of the present disclosure, in the flow cytometer, the upper limit value of the length of the illumination light shaped by the illumination optical system in the length direction of the flow path is 1000 micrometers or less.

Further, according to one aspect of the present disclosure, in the flow cytometer, an upper limit value of the length of the illumination light shaped by the illumination optical system in the width direction of the flow path is equal to or less than a width of the flow path.

Further, according to one aspect of the present disclosure, in the flow cytometer, a lower limit value of the length of the illumination light shaped by the illumination optical system in the width direction of the flow path is equal to or greater than a degree of positional deviation of a flow line of the observation object flowing through the flow path in the width direction of the flow path.

Further, according to one aspect of the present disclosure, in the flow cytometer, the mask for structured detection is set such that a size of a region in which the binary pattern is disposed is 300 μm or less in a width direction and 1500 μm or less in a flow direction on an object plane, and the binary pattern is formed of a plurality of pixels each having a circular shape with a radius of 10 μm or less or a rectangular shape with a side of 10 μm or less on the object plane.

Further, according to one aspect of the present disclosure, in the flow cytometer, the imaging optical system further includes a light blocker disposed between the flow path and the mask for structured detection to block light, and the propagation path of the direct light, which has been transmitted through the observation object, of the illumination light shaped by the illumination optical system and the propagation path of the scattered light emitted from the observation object until the scattered light is detected by the photodetector are spatially separated from each other by the light blocker blocking the direct light.

Further, according to one aspect of the present disclosure, in the flow cytometer, the light blocker is disposed at one or more positions where the direct light shaped by the illumination optical system is most narrowed by at least one of the illumination optical system and the imaging optical system.

Further, according to one aspect of the present disclosure, in the flow cytometer, the illumination optical system shapes the illumination light such that a direction of the propagation path of the direct light, which has been transmitted through the observation object, of the illumination light to be shaped is different from a direction of the propagation path of the scattered light emitted from the observation object until the scattered light is detected by the photodetector.

Further, according to one aspect of the present disclosure, in the flow cytometer, a region in which the binary pattern is disposed in the mask for structured detection is smaller than a region in which the illumination light shaped by the illumination optical system is irradiated on an imaging plane of the imaging optical system.

### Advantageous Effects of Invention

According to the present invention, it is possible to acquire high-resolution information derived from the shape of an observation object only from scattered light using a configuration of structured detection.

### BRIEF DESCRIPTION OF DRAWINGS

FIG. 1 is a view showing an example of a configuration of a flow cytometer according to a first embodiment of the present invention.

FIG. 2 is a view showing an example of a shape of illumination light according to the first embodiment of the present invention.

FIG. 3 is a view showing an example of a first spatial separation configuration according to the first embodiment of the present invention.

FIG. 4 is a view showing a second example of the first spatial separation configuration according to the first embodiment of the present invention.

FIG. 5 is a view showing a third example of the first spatial separation configuration according to the first embodiment of the present invention.

FIG. 6 is a view showing a fourth example of the first spatial separation configuration according to the first embodiment of the present invention.

FIG. 7 is a view showing an example of a second spatial separation configuration according to a modification example of the first embodiment of the present invention.

FIG. 8 is a view showing an example of a binary pattern included in a mask for structured detection according to the first embodiment of the present invention.

FIG. 9 is a view showing an example of a configuration for performing structured detection according to the first embodiment of the present invention.

FIG. 10 is a view showing an example of a configuration for performing structured detection according to a modification example of the first embodiment of the present invention.

FIG. 11 is a view showing an example of a configuration for performing structured detection according to a second embodiment of the present invention.

FIG. 12 is a view showing an example of a configuration for performing structured detection according to a modification example of the second embodiment of the present invention.

FIG. 13 is a view showing an example of a configuration for performing structured detection according to a third embodiment of the present invention.

FIG. 14 is a view showing an example of a configuration for performing structured detection according to a fourth embodiment of the present invention.

### DETAILED DESCRIPTION OF THE EMBODIMENTS

### First Embodiment

Hereinafter, embodiments of the present invention will be described in detail with reference to the drawings.

### Configuration of Flow Cytometer

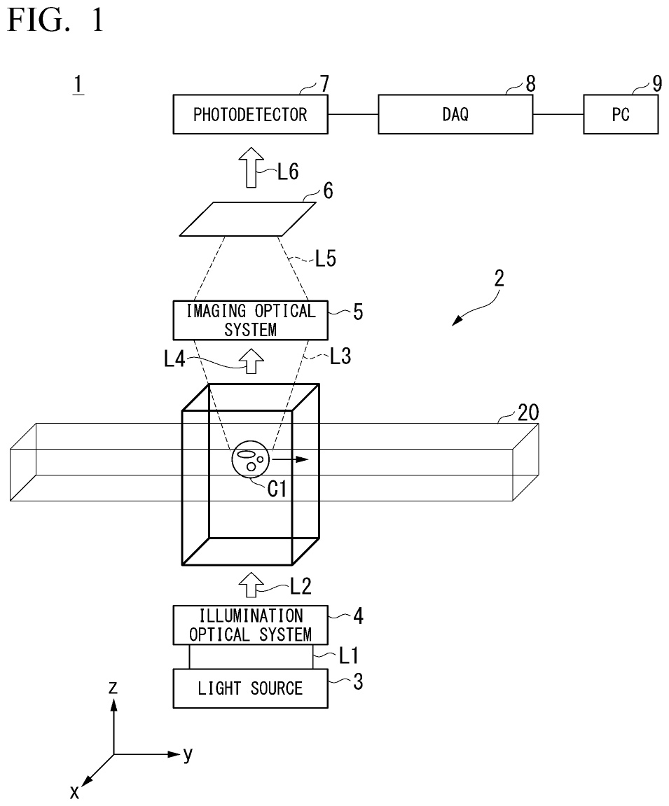

FIG. 1 is a view showing an example of a configuration of a flow cytometer 1 according to the present embodiment. The flow cytometer 1 includes a microfluidic device 2, a light source 3, an illumination optical system 4, an imaging optical system 5, a mask for structured detection 6, a photodetector 7, a DAQ device 8, and a personal computer (PC) 9.

The flow cytometer 1 uses a ghost cytometry (GC) technology to acquire light emitted from an observation object as a signal that can be converted into an image. The flow cytometer 1 acquires information derived from the shape of the observation object through the structured detection on the basis of the GC technology. Here, the structured detection involves a configuration in which the mask for structured detection 6 is provided at a position between a flow path 20 and the photodetector 7 on an optical path from the light source 3 to the photodetector 7.

The microfluidic device 2 includes the flow path 20 through which a cell C1 can flow together with a fluid. The flow rate of the fluid flowing through the flow path 20 is constant during measurement of the observation object. Further, although the microfluidic device 2 sequentially causes a plurality of cells to flow through the flow path 20, the number of cells passing through an irradiation position during measurement of the observation object is one. The cell C1 is an example of the observation object. The observation object is not limited to the cell C1, but may also be micro particles derived from living organisms such as bacteria, micro particles derived from non-living organisms such as plastics, beads, and the like as other examples.

Here, an xyz coordinate system is appropriately shown in the figure as a three-dimensional orthogonal coordinate system. In the present embodiment, an x-axis direction is a width direction of the flow path 20. Further, a y-axis direction is a length direction of the flow path 20. A z-axis direction is a direction orthogonal to the flow path 20 and is a depth direction of the flow path 20. The depth direction of the flow path 20 is also referred to as a height direction of the flow path 20. The flow of a liquid in the flow path 20 moves the cell C1 in a +y direction of the y-axis direction. In other words, the width direction of the flow path 20 or the depth direction of the flow path 20 is a direction perpendicular to a flow line of the fluid flowing together with the cell C1.

The width and depth of the flow path 20 can be appropriately selected depending on the observation object. For example, in a case where the observation object is a cell, the width and depth of the flow path 20 can each be set to about 20 μm to 500 μm, but are not necessarily limited to this range. In the present embodiment, as an example, the width and depth of the flow path 20 are equal to each other. That is, the cross section of the flow path 20 is square. The width and depth of the flow path 20 may be different from each other. That is, the cross section of the flow path 20 may be rectangular.

A flow focusing mechanism may be further added to the flow path 20 to limit the width of the flow line through which the observation object passes.

The light source 3 irradiates illumination light L1 toward the cell C1 flowing through the flow path 20. The illumination light L1 from the light source 3 illuminates the cell C1 flowing through the flow path 20 via the illumination optical system 4. The illumination light L1 irradiated by the light source 3 may be coherent light or incoherent light. An example of the coherent light is laser light, and an example of the incoherent light is light-emitting diode (LED) light. In the present embodiment, the illumination light L1 irradiated by the light source 3 is, for example, coherent light.

The illumination optical system 4 is a mechanism for spatially substantially uniformly illuminating the cell C1 passing through the flow path 20. The illumination optical system 4 includes at least one optical element of a mirror and a lens. The illumination optical system 4 may further include a slit that shapes light and other optical elements. The optical elements constituting the illumination optical system differ depending on the quality of the illumination light L1 irradiated by the light source 3, the optical path from the light source 3 to the irradiation position of the flow path 20, and the method of separating illumination light and scattered light from each other.

The illumination optical system 4 shapes the illumination light L1 irradiated by the light source 3 into illumination light L2 having a predetermined shape at the irradiation position of the flow path 20 and irradiates the illumination light L2. In FIG. 1, the illumination light L2 having the predetermined shape is shown using a rectangular parallelepiped as an example. It is preferable that the illumination light L2 be parallel light.

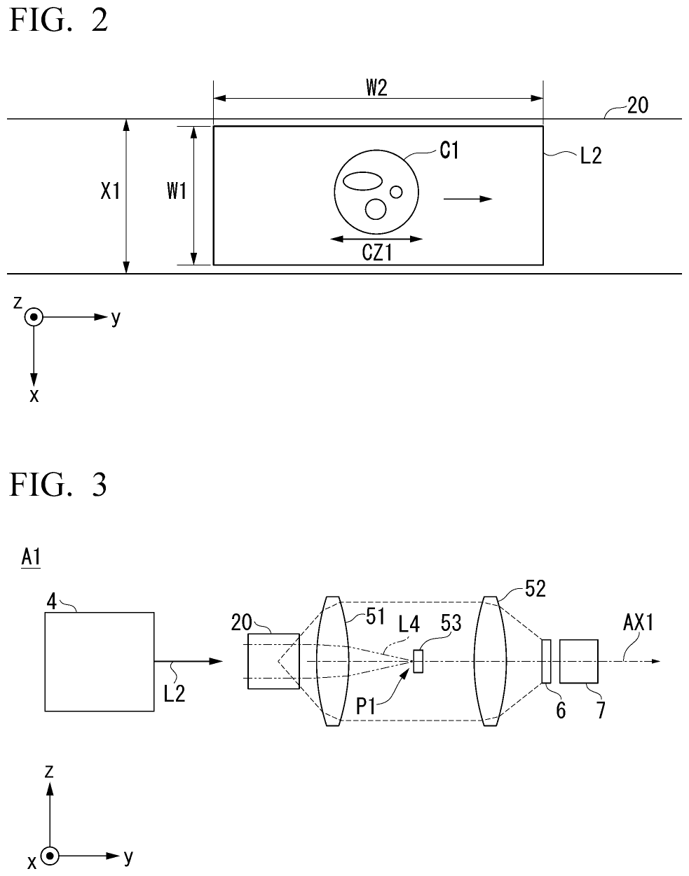

Here, with reference to FIG. 2, the shape of the illumination light L2 will be described. FIG. 2 is a view showing an example of the shape of the illumination light L2 according to the present embodiment. FIG. 2 shows the shape of the illumination light L2 irradiated to the irradiation position of the flow path 20 when the flow path 20 shown in FIG. 1 is viewed from above. The shape of the illumination light L2 at the irradiation position of the flow path 20 is approximately rectangular. In the rectangle, the length in the width direction of the flow path 20 is a width direction length W1, and the length in the length direction of the flow path 20 is a length direction length W2. The length direction of the flow path 20 is a flow direction of the fluid flowing through the flow path 20. In the present embodiment, the length direction length W2 is longer than the width direction length W1. In other words, the width direction length W1 and the length direction length W2 correspond to a short side and a long side of the rectangle, respectively. Therefore, the illumination optical system 4 shapes the illumination light L1 irradiated by the light source 3 into the illumination light L2 of which the length direction length W2 is equal to or greater than the width direction length W1 at the irradiation position of the flow path 20 and irradiates the illumination light L2.

The length direction length W2 is any length in the range of 30 μm to 2000 μm. More preferably, the length direction length W2 is any length in the range of 50 μm to 1000 μm.

As the range of the length direction length W2, the range of 50 μm to 1000 μm described above is determined from a lower limit value and an upper limit value from a practical viewpoint.

In order to acquire detailed information derived from the shape of the observation object using the GC technology, it is preferable that the length direction length W2 of the illumination light L2 irradiated to the observation object be sufficiently longer than the size of the observation object (for example, a cell size CZ1). As described above, the cell size CZ1 is approximately 5 μm to 20 μm. In this respect, at least the length direction length W2 needs to be larger than the cell size CZ1 of the cell C1, which is the observation object. Furthermore, in order to acquire the scattered light emitted from the cell C1 as information derived from the shape with high resolution by which the cell C1 can be discriminated without fluorescent labeling, it is desirable to set the length direction length W2 of the illumination light L2 to a length of 50 μm or more, and it is more desirable to set the length direction length W2 of the illumination light L2 to a length of 100 μm or more.

On the other hand, assuming that the amount of illumination light L1 irradiated from the light source 3 is constant, when the illumination light L2 is irradiated over a wide area, the amount of illumination light L2 per unit area decreases. If the amount of the illumination light L2 per unit area is too small, a ratio of the signal to noise (an S/N ratio) will become small. For this reason, in order to maintain a sufficiently large S/N ratio while ensuring the necessary length in the width direction of the flow path 20, it is preferable that the length direction length W2 of the illumination light L2 be 1000 μm or less. It is more preferable that the length direction length W2 of the illumination light L2 be 500 μm or less.

Furthermore, if the length direction length W2 is increased, it takes longer to detect the scattered light, and thus the throughput (the measuring speed per sample of the flow cytometer) becomes slower. That is, if the length direction length W2 is set longer, the desired throughput may not be obtained. From this point of view, it is necessary to determine the length direction length W2 such that the throughput is not less than the desired throughput.

In this way, from a practical standpoint, the length direction length W2 is desirably in the range of 50 μm to 1000 μm.

On the other hand, as the range of the length direction length W2, the range of 30 μm to 2000 μm described above is determined from the theoretical lower limit value and upper limit value.

Although the illumination light L2 is imaged on the mask for structured detection 6 as will be described below, the lower limit value of the length direction length W2 of 30 μm described above is, for example, a lower limit value determined by considering the length at which the minimum number of pixels (for example, 70 to 80 pixels) can be effectively disposed according to the resolution required to discriminate the cell C1.

The upper limit value of the length direction length W2 of 2000 μm described above is an upper limit value determined by the limit determined by the optical system provided in the imaging optical system 5. The limit determined by the optical system is, for example, the size of a field of view of an objective lens. In a case where the length direction length W2 is made longer than the size of the field of view of the objective lens, even if scattered light is emitted from the cell C1 when the illumination light L2 passes outside the field of view of the objective lens, such scattered light cannot be detected by the photodetector 7 in the first place.

In the example shown in FIG. 2, the width direction length W1 is shorter than a flow path width X1, which is the length of the width of the flow path 20. It is preferable that the width direction length W1 is equal to or less than the flow path width X1. This is because, in a case where the width direction length W1 is longer than the flow path width X1, the illumination light L2 is excessively irradiated to the outside of the flow path 20 through which the cell C1 does not pass, and the amount of light is wasted. The flow path width X1 is set to a size that allows the fluid containing the cell C1 to flow through the flow path 20 without clogging the fluid and without damaging the cell C1. Considering that the cell size CZ1 of general cells is about 5 μm to 20 μm, the flow path width X1 is often set in the range of 50 μm to 300 μm. As an example, in a case where the flow path width X1 is 100 μm, the width direction length W1 is set to 100 μm or less.

It is preferable that the width direction length W1 is equal to or greater than the degree of positional deviation of the flow line of the cell C1. The positional deviation of the flow line refers to the fact that the passing positions of the observation objects flowing along with the fluid through the flow path vary and become unstable in the width direction of the flow path. In a case where the width direction length W1 is equal to or greater than the degree of the positional deviation of the flow line, even if the positional deviation of the flow line of the cell C1 occurs, it is possible to suppress a large change in the intensity of the illumination light L2 irradiated when the cell C1 is out of the irradiation position of the illumination light L2.

Moreover, it is preferable that the width direction length W1 be equal to or greater than the cell size CZ1. The cell size CZ1 is a size of the cell C1, which is an observation object. Although the cell size CZ1 varies depending on the type of cell, the size is often about 5 μm to 20 μm. In the flow cytometer 1, in order to acquire information derived from the shape of the observation object, it is preferable that all portions of the observation object be irradiated with the illumination light L2. For this reason, it is preferable that the width direction length W1 be equal to or greater than the size of the observation object.

Here, in the flow cytometer of the related art, the illumination light for acquiring forward scatter (FSC) was illumination light used not only to acquire the FSC but also to excite a fluorescent dye, and thus the illumination light needed to be irradiated to the cell at a high intensity. For this reason, the illumination light needs to be focused. On the other hand, in order to suppress a large change in the intensity of the illumination light irradiated to the cell even if the positional deviation of the flow line occurs, the illumination light is required to be widened in the width direction of the flow path. Due to these requirements, in the flow cytometer of the related art, the illumination light was irradiated widely in the width direction of the flow path and narrowly in the flow direction (the flow line direction) of the flow path, taking into account the positional deviation of the flow line.

On the other hand, as described above, in the flow cytometer 1 according to the present embodiment, the scattered light from the cell C1 is acquired as a signal that can be converted into an image using the GC technology through the structured detection. For the structured detection, the flow cytometer 1 needs to acquire the scattered light emitted from the cell C1 passing through the flow path 20 to be subjected to a pattern of the mask for structured detection 6. For this reason, in the flow cytometer 1, it is necessary to irradiate the illumination light L2 widely in the flow direction (the flow line direction) of the flow path 20.

In the present embodiment, an example in which the length direction length W2 is longer than the width direction length W1 has been described, but the present invention is not limited to this. In the flow cytometer of the related art, in order to acquire the FSC, typically, the illumination light with a width of about 100 μm in the width direction of the flow path and about 10 μm in the length direction of the flow path was irradiated to the flow path. That is, the illumination light used in the flow cytometer of the related art was irradiated to the flow path such that the length of the illumination light in the length direction of the flow path was about 1/10 of the length of the illumination light in the width direction of the flow path. On the other hand, in the flow cytometer 1 according to the present embodiment, regarding the shape of the illumination light L2, the ratio of the length in the length direction of the flow path 20 to the length in the width direction of the flow path 20 is larger than that of the illumination light used in the flow cytometer of the related art. As a result, it is possible to irradiate the illumination light L2 that is wider in the flow direction of the flow path than that of the related art.

That is, in the flow cytometer 1, regarding the shape of the illumination light L2, it is acceptable that the ratio of the length in the length direction of the flow path 20 (the length direction length W2) to the length in the width direction of the flow path 20 (the width direction length W1) is any predetermined ratio that is larger than 1/10. For example, the ratio of the length direction length W2 to the width direction length W1 may be ⅕. Even in that case, the range of the length direction length W2 is in the range of 30 μm to 2000 μm due to theoretical requirements.

In a case where the length direction length W2 is changed in the range of 30 μm to 2000 μm, in order to make the intensity of the illumination light L2 irradiated to the cell C1 to be equal to or greater than a predetermined level, it is preferable that the length direction length W2 and the width direction length W1 be changed while the ratio of the length direction length W2 to the width direction length W1 is kept to be a predetermined ratio that is larger than 1/10. As long as the intensity of the illumination light L2 is equal to or greater than a predetermined value, the ratio of the length direction length W2 to the width direction length W1 may be changed from the predetermined ratio as long as the ratio is larger than 1/10.

Returning to FIG. 1, the description of the configuration of the flow cytometer 1 will be continued.

The illumination light L2 shaped by the illumination optical system 4 is irradiated to the irradiation position in the flow path 20. When the cell C1 passes through the irradiation position, the cell C1 is irradiated with the illumination light L2. When the illumination light L2 is irradiated to the cell C1, the illumination light L2 is scattered by the cell C1, and scattered light L3 is emitted from the cell C1. Furthermore, when the illumination light L2 is irradiated to the cell C1, a fluorescent molecule contained in the cell C1 is excited and emits light. In a case where the fluorescent molecule emits light, fluorescence is emitted from the cell C1. A component of the illumination light L2 irradiated to the cell C1 which has been transmitted through the cell C1 propagates to the imaging optical system 5 as direct light L4 (also referred to as transmitted light).

The imaging optical system 5 images the scattered light L3 emitted from the cell C1 on the mask for structured detection 6. The imaging optical system 5 includes an imaging lens. The scattered light L3 is focused and imaged at a position where the mask for structured detection 6 is provided, by the imaging lens. In FIG. 1, the scattered light L3 focused by the imaging lens is shown as scattered light L5. The imaging optical system 5 may be either an infinite correction system or a finite correction system. Specific examples of the configuration of the imaging optical system 5 will be described below.

The mask for structured detection 6 constitutes transmitting portions and blocking portions. The transmitting portions are the regions through which light is transmitted. The blocking portions are the regions that block light. To block light in the blocking portions, methods such as absorption, reflection, refraction, and diffraction of light are used singly or in combination. The mask for structured detection 6 has a binary pattern constituted by the transmitting portions and the blocking portions, and the pattern of the region through which light is transmitted is determined according to the arrangement of the transmitting portions. Only the component of the scattered light L5 which has been transmitted through the transmitting portions of the mask for structured detection 6 is detected by the photodetector 7. In FIG. 1, the component of the scattered light L5 which has been transmitted through the transmitting portions is shown as scattered light L6.

The photodetector 7 detects the scattered light L6 transmitted through the transmitting portions of the mask for structured detection 6. The scattered light L6 detected by the photodetector 7 may be scattered light that is scattered in any direction. That is, the scattered light L6 may be any of the FSC, the side scatter (SSC), and the backward scatter (BSC). In the present embodiment, as an example, a case in which the FSC is detected as the scattered light L6 will be described. That is, in the present embodiment, as an example, a case in which the FSC scattered forward of the scattered light emitted by the cell C1 is detected by the configuration of the structured detection will be described.

The DAQ device 8 converts the electrical signal waveform output by the photodetector 7 into electronic data for each waveform. The electronic data includes a combination of time and the intensity of the electrical signal. The DAQ device 8 is, for example, an oscilloscope.

The PC 9 analyzes the cell C1 on the basis of the electronic data output from the DAQ device 8 and generates optical information. The PC 9 can also store optical information generated by itself.

As described above, the mask for structured detection 6 having the binary pattern is disposed at a position where the scattered light L3 emitted from the cell C1 is imaged by the imaging optical system 5. As a result, the scattered light L6 detected by the photodetector 7 becomes a signal convoluted with information derived from the shape of the cell C1.

As the cell C1 moves through the flow path 20, the position where the cell C1 is imaged on the mask for structured detection 6 changes in accordance with the movement of the cell C1. In a case where the binary pattern of the mask for structured detection 6 is a random pattern, that is, in a case where the regions of the mask for structured detection 6 through which light is transmitted (the transmitting portions) are disposed without regularity, it is possible, for example, to estimate the shape of the cell C1 from the time-series change in the intensity of the scattered light L6 detected when the cell C1 moves through the flow path 20.

Even if the binary pattern of the mask for structured detection 6 is not long enough for image reconstruction in the length direction (the flow line direction) of the flow path 20, it is possible to discriminate the target cell or the like that has been learned once using machine learning (see, for example, Patent Documents 3 and 4, and Non-Patent Document 1).

Here, in the flow cytometer 1, the propagation path of the direct light L4 and the propagation path of the scattered light L3 are spatially separated from each other by the illumination optical system 4 and the imaging optical system 5. The direct light L4 is the component of the illumination light L2 shaped by the illumination optical system 4 which has been transmitted through the cell C1 as described above. Therefore, the propagation path of the illumination light L2 shaped by the illumination optical system 4 and the propagation path of the scattered light L3 emitted from the cell C1 until the scattered light L3 is detected by the photodetector 7 are spatially separated from each other by the illumination optical system 4 and the imaging optical system 5. The scattered light L3 is detected by the photodetector 7 via the mask for structured detection 6 as the scattered light L6.

Configuration for Spatially Separating Direct Light and Scattered Light from Each Other

Here, with reference to FIGS. 3 to 7, configurations for spatially separating the propagation path of the direct light L4 and the propagation path of the scattered light L3 from each other by the illumination optical system 4 and the imaging optical system 5 will be described. An example of the configurations is a configuration in which the direct light L4 is blocked by a light blocker (referred to as a first spatial separation configuration). Further, another example of the configurations is a configuration in which a direction of an optical axis of the imaging optical system 5 is deviated from a direction in which the direct light L4 propagates without providing the light blocker (referred to as a second spatial separation configuration).

FIG. 3 is a view showing a first spatial separation configuration A1 according to the present embodiment. The first spatial separation configuration A1 is an example of the first spatial separation configuration. In the first spatial separation configuration A1, the imaging optical system 5 includes a detection lens 51, an imaging lens 52, and a light blocker 53. The optical axis of the imaging optical system 5 is referred to as an imaging optical system optical axis AX1. The detection lens 51, the light blocker 53, and the imaging lens 52 are provided in that order from the flow path 20 toward the photodetector 7 on the imaging optical system optical axis AX1. That is, the detection lens 51 is provided at a position closest to the flow path 20 among the imaging lenses included in the imaging optical system 5. The imaging lens 52 is provided at a position closest to the photodetector 7 among the imaging lenses included in the imaging optical system 5.

A component of the illumination light L2 irradiated from the illumination optical system 4 which has been transmitted through the cell C1 flowing through the flow path 20 is input to the imaging optical system 5 as the direct light L4. In FIG. 3, the illumination light L2 is input to the cell C1 flowing through the flow path 20 as parallel light by the illumination optical system 4. For this reason, a propagation direction of the direct light L4 is approximately parallel to the imaging optical system optical axis AX1. The direct light L4 input to the imaging optical system 5 propagates toward the photodetector 7 substantially to be parallel to the imaging optical system optical axis AX1. The direct light L4 is focused by the detection lens 51.

Here, the position P1 is a position where the direct light L4 is most narrowed by the detection lens 51 on the imaging optical system optical axis AX1. In the first spatial separation configuration A1, the position P1 is a position between the detection lens 51 and the imaging lens 52 on the imaging optical system optical axis AX1. In FIG. 3, the light blocker 53 is installed at the position P1 on the imaging optical system optical axis AX1.

The light blocker 53 blocks the light that is input to itself and does not allow the light to be transmitted through itself. That is, the light blocker 53 blocks the direct light L4 that is input to itself. The size of the light blocker 53 is larger than an extent in a direction orthogonal to the propagation direction of the direct light L4 in a case where the direct light L4 is input to itself. The light blocker 53 is, for example, a light blocking plate.

The light blocker 53 is disposed between the flow path 20 and the mask for structured detection 6 on the imaging optical system optical axis AX1. In the first spatial separation configuration A1, the light blocker 53 is disposed at the position P1. As in the example in FIG. 3, it is preferable that the light blocker 53 be disposed at the position P1, but the light blocker 53 may be disposed at any position on the imaging optical system optical axis AX1 as long as the position is between the flow path 20 and the mask for structured detection 6.

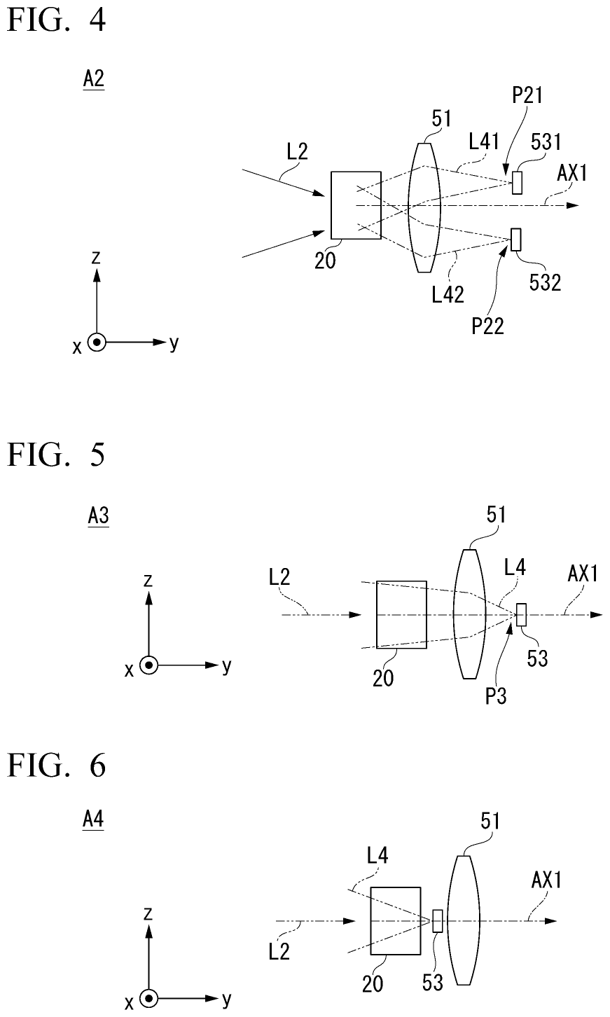

FIG. 4 is a view showing an example of a first spatial separation configuration A2 according to the present embodiment. The first spatial separation configuration A2 is a second example of the first spatial separation configuration. In the description of the first spatial separation configuration A2, parts that are different from the first spatial separation configuration A1 (FIG. 3) will be mainly explained. The first spatial separation configuration A2 includes two light blockers, a light blocker 531 and a light blocker 532.

In the first spatial separation configuration A2, the propagation direction of the illumination light L2 is a direction of the imaging optical system optical axis AX1, but the illumination light L2 does not necessarily need to be collimated by the illumination optical system 4. In the first spatial separation configuration A2 illustrated in FIG. 4, the direct light L4 is input to the imaging optical system 5 in a plurality of directions. Of the direct light L4 that is input from the plurality of directions to the imaging optical system 5, the light which propagates in the direction of the imaging optical system optical axis AX1, is blocked by the light blockers.

Direct light L41 and direct light L42 are each focused by the detection lens 51. The position P21 is a position where the direct light L41 is most narrowed. The position P22 is a position where the direct light L42 is most narrowed. Alight blocker 531 is disposed at the position P21. Alight blocker 532 is disposed at the position P22. The light blocker 531 and the light blocker 532 block the direct light L41 and the direct light L42 propagating in the direction of the imaging optical system optical axis AX1, respectively. It is preferable that the light blocker 531 and the light blocker 532 be disposed at the position P21 and the position P22, respectively, as shown in FIG. 4, but the present invention is not limited to this.

In the first spatial separation configuration A2, an example in which two light blockers, the light blocker 531 and the light blocker 532, are provided has been described, but the present invention is not limited to this. In the first spatial separation configuration A2, the number of light blockers may be provided depending on the number of propagation directions of the direct light L4.

FIG. 5 is a view showing an example of a first spatial separation configuration A3 according to the present embodiment. The first spatial separation configuration A3 is a third example of the first spatial separation configuration. In the description of the first spatial separation configuration A3, parts that are different from the first spatial separation configuration A1 (FIG. 3) will be mainly explained.

In the first spatial separation configuration A3, the propagation direction of the illumination light L2 is a direction of the imaging optical system optical axis AX1, but the illumination light L2 is not collimated by the illumination optical system 4. In the first spatial separation configuration A3, the direct light L4 is not input to the flow path 20 and the detection lens 51 as a parallel light flux, but the light flux propagates in the direction of the imaging optical system optical axis AX1.

The direct light L4 is focused by the detection lens 51. The position P3 is a position where the direct light L4 is most narrowed. The light blocker 53 is disposed at the position P3 on the imaging optical system optical axis AX1. The light blocker 53 blocks the direct light L4 propagating in the direction of the imaging optical system optical axis AX1. Although the light blocker 53 can be disposed at another location on the imaging optical system optical axis AX1, it is preferable that the light blocker 53 be disposed at the position P3 where the direct light L4 is most narrowed, as in the example of FIG. 5.

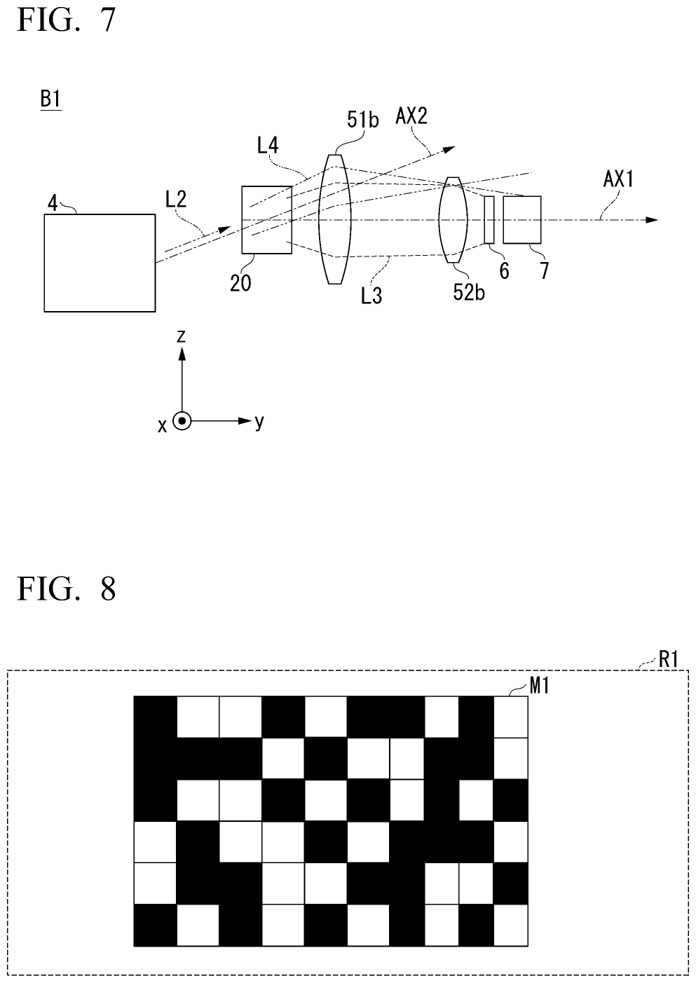

FIG. 6 is a view showing an example of a first spatial separation configuration A4 according to the present embodiment. The first spatial separation configuration A4 is a fourth example of the first spatial separation configuration. In the description of the first spatial separation configuration A4, parts that are different from the first spatial separation configuration A1 (FIG. 3) will be mainly explained.

In the first spatial separation configuration A4, the propagation direction of the illumination light L2 is a direction of the imaging optical system optical axis AX1, but the illumination light L2 is not collimated by the illumination optical system 4. In the first spatial separation configuration A4, the light blocker 53 is disposed at a position closer to the flow path 20 than the detection lens 51 on the imaging optical system optical axis AX1. That is, in the first spatial separation configuration A4, the direct light L4 propagating in the direction of the imaging optical system optical axis AX1 is blocked before the direct light L4 is input to the detection lens 51.

As described above, in the first spatial separation configuration, the imaging optical system 5 includes the light blocker 53 that is disposed between the flow path 20 and the mask for structured detection 6 and blocks the direct light L4. In the first spatial separation configuration, the propagation path of the illumination light shaped by the illumination optical system 4 (the direct light L4) and the propagation path of the scattered light L3 emitted from the observation object (the cell C1) until the scattered light L3 is detected by the photodetector 7 are spatially separated from each other by the light blocker 53 blocking the illumination light (the direct light L4) shaped by the illumination optical system 4.

The direct light L4 becomes noise in a case where the scattered light L3 is detected as a signal. In the first spatial separation configuration, by providing the light blocker 53, the propagation path of the direct light L4 which becomes noise and the propagation path of the scattered light L3 can be spatially separated from each other, and thus it is possible to reduce the noise compared to a case where the light blocker 53 is not provided.

In the first spatial separation configuration, the divergence angle and the propagation direction of the illumination light L2 are adjusted such that one or more positions where the direct light L4 is most narrowed by at least one of the illumination optical system 4 and the imaging optical system 5 are realized between the flow path 20 and the mask for structured detection 6 on the imaging optical system optical axis AX1. In the first spatial separation configuration, it is preferable that the light blocker 53 be disposed at one or more positions where the illumination light shaped by the illumination optical system 4 (the direct light L4) is most narrowed (for example, the position P1) by at least one of the illumination optical system 4 and the imaging optical system 5. With this configuration, it is possible to block a large amount of the illumination light (the direct light L4) compared to the case where the light blocker 53 is not disposed at one or more positions where the illumination light shaped by the illumination optical system 4 (the direct light L4) is most narrowed, and thus it is possible to reduce the noise.

As another example of the first spatial separation configuration, the illumination light L2 may be input to the imaging optical system 5 in a state in which the illumination light L2 is made parallel by the illumination optical system 4 only in one axial direction (for example, the x-axis direction) among the directions perpendicular to the imaging optical system optical axis AX1 and is slightly narrowed by the illumination optical system 4 in a direction perpendicular to the axial direction (for example, the z-axis direction). In that case, the illumination optical system 4 includes, for example, a cylindrical lens.

Next, with reference to FIG. 7, a second spatial separation configuration according to the present embodiment will be described. FIG. 7 is a view showing an example of a second spatial separation configuration B1 according to the present embodiment. The second spatial separation configuration B1 is an example of the second spatial separation configuration. The direction of the propagation path of the illumination light L2 formed by the illumination optical system 4 is defined as an illumination light propagation axis AX2.

The direct light L4, which is illumination light L2 that has been transmitted through the cell C1, propagates in the direction of the illumination light propagation axis AX2. In the second spatial separation configuration B1, the direction of the illumination light propagation axis AX2 is deviated in a direction different from the direction of the imaging optical system optical axis AX1 by the illumination optical system 4.

In the example shown in FIG. 7, the imaging optical system optical axis AX1 is parallel to a y axis, whereas the illumination light propagation axis AX2 is inclined from the y axis toward a z axis. The direct light L4 propagates in the direction of the illumination light propagation axis AX2, and propagates in a direction in which the direct light L4 is not input to the photodetector 7 via the detection lens 51b. Here, the imaging lens 52b images the scattered light L3 made substantially parallel by the detection lens 51b onto the mask for structured detection 6.

In a case where there are a plurality of illumination light propagation axes AX2, the direct light L4 propagating in each direction of the plurality of illumination light propagation axes AX2 propagates in a direction in which the direct light L4 is not input to the photodetector 7 via the detection lens 51b.

In the second spatial separation configuration B1, unlike the first spatial separation configuration described above, the light blocker 53 is not provided.

In the second spatial separation configuration, the illumination optical system 4 shapes the illumination light L2 such that the direction of the propagation path of the illumination light L2 to be shaped (the direction of the illumination light propagation axis AX2) is different from the direction of the propagation path of the scattered light L3 emitted from the observation object (the cell C1) until the scattered light L3 is detected by the photodetector 7 (the direction of the imaging optical system optical axis AX1).

In the second spatial separation configuration, the propagation path of the illumination light L2 shaped by the illumination optical system 4 and the propagation path of the scattered light L3 emitted from the observation object until the scattered light L3 is detected by the photodetector 7 are spatially separated from each other without providing the light blocker, and thus it is possible to reduce the noise with a simple configuration.

### Configuration of Binary Pattern

FIG. 8 is a view showing an example of a binary pattern M1 included in the mask for structured detection 6 according to the present embodiment. The irradiation region R1 is a region in which the illumination light L2 shaped by the illumination optical system 4 is irradiated to the observation object (the cell C1) passing through the flow path 20, and the scattered light L3 emitted from the cell C1 is emitted onto an imaging plane of the imaging optical system 5. As shown in FIG. 8, the region in which the binary pattern M1 is disposed in the mask for structured detection 6 is smaller than the irradiation region R1 or approximately the same size as the irradiation region R1 when compared on an object plane. Here, the object plane is a plane at a position in the flow path 20 where the cell C1 is present. Comparing the size of the binary pattern M1 of the mask for structured detection 6 with the size of the cell C1 on the object plane means comparing the size of an image of the binary pattern M1 of the mask for structured detection 6 formed on the flow path 20 with the size of the cell C1 passing through the position of that image in the flow path 20.

With this configuration, it is ensured that in the flow cytometer 1, the scattered light L3 emitted when the observation object is irradiated with the illumination light L2 in a wide irradiation region in the length direction (the flow line direction) of the flow path 20 is efficiently detected via the transmitting portions included in the binary pattern M1. In a case where the region in which the binary pattern M1 is disposed is larger than the irradiation region R1, a region of the binary pattern M1 which is not irradiated with the illumination light L2 occurs, resulting in a portion that is not used for structured detection.

The size of the region in which the binary pattern M1 is disposed in the mask for structured detection 6 is determined on the basis of the width of the flow path 20, the degree of flow focusing, the size of the observation object, and the size of a target part (an internal structure to be observed) of the observation object. For example, in a case where the observation object is the cell C1, it is preferable that the size of the region in which the binary pattern M1 is disposed in the width direction be set to be 300 μm or less on the object plane in the direction perpendicular to the flow (the width direction of the flow path 20). On the other hand, it is preferable that the size of the region in which the binary pattern M1 is disposed in the flow direction (the length direction of the flow path 20) be set to be 1500 μm or less on the object plane (the position where the cell C1 is present).

The binary pattern M1 is determined according to the arrangement of the transmitting portions, and the transmitting portions are configured as an aggregate of a plurality of pixels. Here, the pixel is the smallest unit constituting a transmitting portion of the binary pattern M1, and the transmitting portions are disposed on the binary pattern M1 with the pixel as the unit. Since the binary pattern M1 is constituted by a plurality of pixels, it is possible to divide the observation object and to detect the scattered light for each part.

The binary pattern M1 is fixed and does not change while the flow cytometer 1 is performing measurement. For example, the transmitting portions or the blocking portions are irregularly (randomly) disposed on the binary pattern M1 with the pixel as the unit. Moreover, the binary pattern M1 can be disposed linearly instead of irregularly. The binary pattern M1 can be constituted by, for example, 2 to 1 million pixels. In addition, the optimum proportion of the entire transmitting portion in the region in which the binary pattern M1 is disposed changes depending on the size of the observation object (in a case where the target part is a part of the cell, the size of the target part) and the intensity of the illumination light L2 irradiated to the observation object. The intensity of the detection light increases as the proportion of the entire transmitting portion increases. On the other hand, it is possible to improve the spatial resolution by setting the proportion of the transmitting portions to 10% or less of the region in which the binary pattern M1 is disposed.

The size and shape of the pixel forming the binary pattern M1 are adjusted as appropriate depending on the size of the target part included in the observation object. The size of the pixel is suitably set to be sufficiently small relative to the size of the target part.

For example, in a case where the observation object is a mammalian cell and the discrimination of the cell is performed on the basis of the shape of the cell (the target part is the entire cell), the size and shape of the pixel is shaped into, for example, a circle with a radius of m or less or a rectangle with a side of 10 μm or less on the object plane, although it also depends on the cell as the observed object. Furthermore, in a case where the observation object is a mammalian cell and the target part is the nucleus of the cell, the size and shape of the pixel is shaped into, for example, a circle with a radius of 1 μm or less or a square with a side of 1 μm or less on the object plane. Here, the diameter of the nucleus of the mammalian cell is approximately 6 μm.

The shape of the pixel is suitably designed as a square, a rectangle, a circle, or an ellipse, but the present invention is not limited to these, and may be formed in other shapes such as a polygon.

### Configuration of Structured Detection

Hereinafter, details of the configuration for performing the structured detection using the flow cytometer 1 will be described.

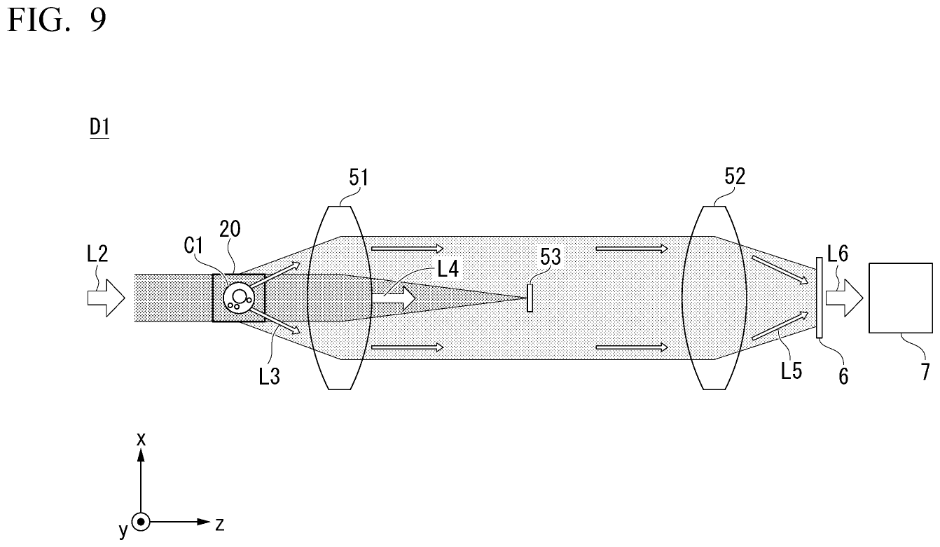

FIG. 9 is a view showing an example of a configuration D1 for performing the structured detection according to the present embodiment. The configuration D1 is a configuration for detecting the FSC through the structured detection in the infinite correction system. In the configuration D1, the imaging optical system 5 includes the detection lens 51, the imaging lens 52, and the light blocker 53.

The illumination light L2 irradiated from the illumination optical system 4 is irradiated to the cell C1 passing through the irradiation position of the flow path 20. The scattered light is emitted from the cell C1 irradiated with the illumination light L2. The FSC that is scattered in the irradiation direction of the illumination light L2 of the scattered light is input to the detection lens 51 as the scattered light L3. Furthermore, a component of the illumination light L2 irradiated to the cell C1 which has been transmitted through the cell C1 is input to the detection lens 51 as the direct light L4.

The scattered light L3 that has passed through the detection lens 51 is input to the imaging lens 52 as an infinite parallel light flux. The scattered light L3 that has been input to the imaging lens 52 is imaged as the scattered light L5 at the position where the mask for structured detection 6 is disposed. The scattered light L6, which is the FSC that has been transmitted through the mask for structured detection 6, is detected by the photodetector 7.

Here, the configuration D1 includes the above-described first spatial separation configuration A1 (FIG. 3) as a configuration for spatially separating the propagation path of the direct light L4 and the propagation path of the scattered light L3 from each other. The direct light L4 is focused by the detection lens 51, and is blocked by the light blocker 53 at the most narrowed position.

### Modification Example of First Embodiment

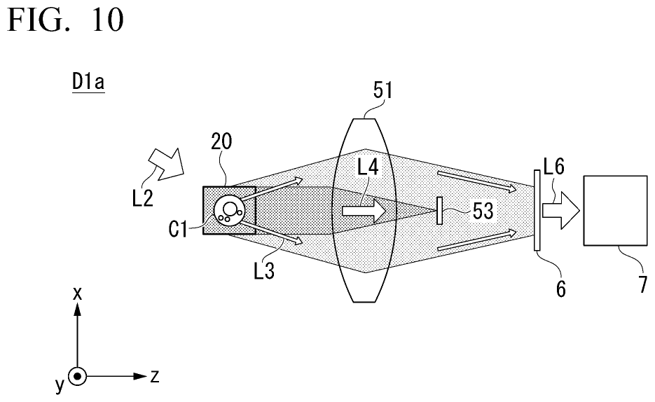

FIG. 10 is a view showing an example of a configuration D1a for performing the structured detection according to a modification example of the present embodiment. In the present modification example, the configuration other than the configuration for performing the structured detection is common to the first embodiment, and here, the configuration D1a will be described. The configuration D1a is a configuration for detecting the FSC in the finite correction system. In the configuration D1a, the imaging optical system 5 includes the detection lens 51 and the light blocker 53.

The scattered light L3 that has passed through the detection lens 51 is imaged by the detection lens 51 at the position where the mask for structured detection 6 is disposed.

The direct light L4 is focused by the detection lens 51, and is blocked by the light blocker 53 at the most narrowed position.

### Second Embodiment

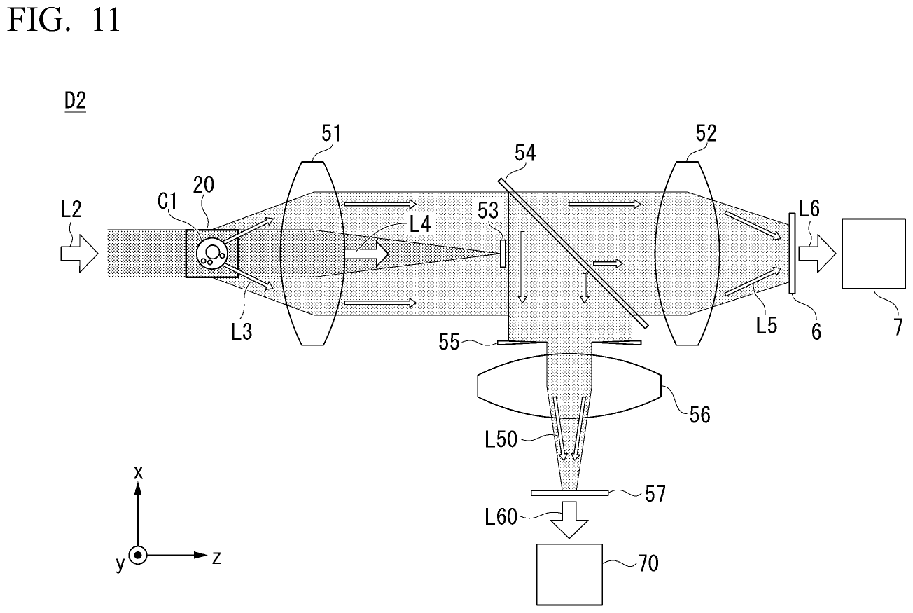

FIG. 11 is a view showing an example of a configuration D2 for performing the structured detection according to the present embodiment. The configuration D2 is a configuration for detecting the FSC through the structured detection in the infinite correction system and at the same time for detecting the FSC that is detected by the flow cytometer of the related art.

The same constituent elements as those in the first embodiment described above are designated by the same reference signs, and descriptions of the same constituent elements and operations may be omitted.

In the configuration D2, the imaging optical system 5 includes a detection lens 51, an imaging lens 52, a light blocker 53, a beam splitter 54, a slit 55, an imaging lens 56, and a rectangular window mask 57. The configuration D2 includes a photodetector 70 for detecting the FSC that is detected by the flow cytometer of the related art.

The beam splitter 54 transmits a part of the input light and reflects the remaining part.

The slit 55 functions as a diaphragm that adjusts the amount of the input light. An aperture may be provided instead of the slit 55.

The rectangular window mask 57 is a mask with a rectangular window that transmits light.

The scattered light L3 that has passed through the detection lens 51 propagates toward the imaging lens 52 as an infinite parallel light flux. Here, a part of the scattered light L3 is transmitted toward the imaging lens 52 by the beam splitter 54, and the rest is reflected toward the imaging lens 56. The scattered light L3 that has been transmitted toward the imaging lens 52 is focused by the imaging lens 52, and is imaged as the scattered light L5 at a position where the mask for structured detection 6 is disposed. The scattered light L6 that has been transmitted through the mask for structured detection 6 is detected by the photodetector 7. The scattered light L6 that is detected by the photodetector 7 via the mask for structured detection 6 includes information derived from the shape of the observation object that is detected by the configuration of the structured detection.

On the other hand, the scattered light L3 reflected toward the imaging lens 56 passes through the slit 55 and is then focused by the imaging lens 56 as scattered light L50. The focused scattered light L50 passes through the rectangular window mask 57 and is then detected by the photodetector 70 as scattered light L60. The scattered light L60 that is detected by the photodetector 70 is light that is detected as the FSC in the flow cytometer of the related art.

### Modification Example of Second Embodiment

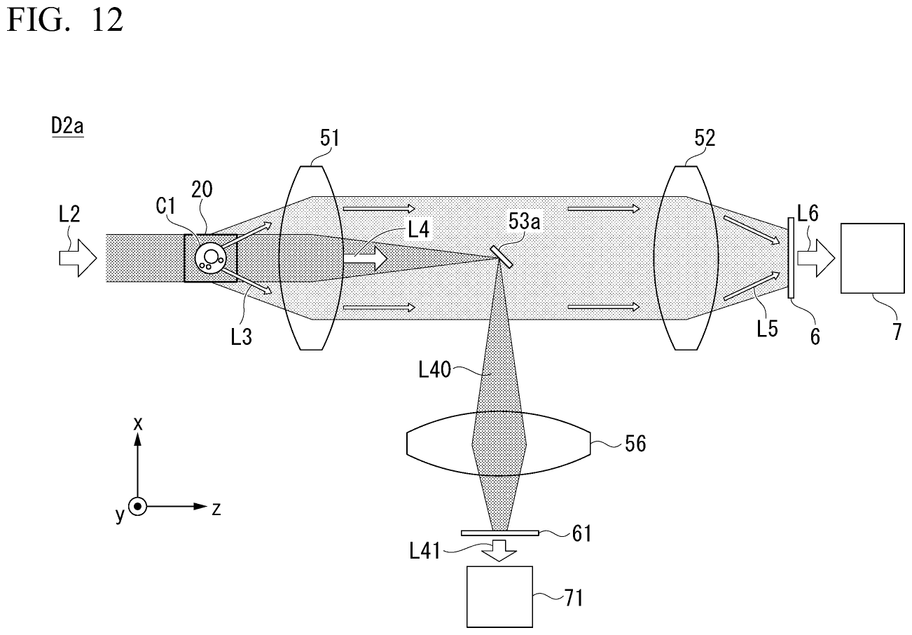

FIG. 12 is a view showing an example of a configuration D2a for performing structured detection according to a modification example of the present embodiment. The configuration D2a is a configuration for detecting the FSC through the structured detection in the infinite correction system and at the same time for performing bright field light detection. In the modification example of the present embodiment, the configuration for performing the structured detection is almost the same as that of the second embodiment, and thus the configuration for performing the bright field light detection will be described below.

In the configuration D2a, the imaging optical system 5 includes the detection lens 51, the imaging lens 52, a mirror 53a, and the imaging lens 56. The configuration D2a includes a mask for structured detection 61 and a photodetector 71 for bright field light detection.

The mirror 53a reflects the direct light L4 toward the photodetector 71 for bright field light detection. On the other hand, since the direct light L4 is reflected by the mirror 53a, the direct light L4 does not propagate toward the photodetector 7 similarly to the first spatial separation configuration A1. That is, the mirror 53a has both a function of reflecting the direct light L4 for bright field light detection and a function of blocking the direct light L4 similarly to the first spatial separation configuration A1.

Similarly to the mask for structured detection 6, the mask for structured detection 61 is a mask having a binary pattern.

The direct light L4 that has been transmitted through the detection lens 51 is reflected toward the photodetector 71 by the mirror 53a. The reflected direct light L4 is input to the imaging lens 56 as direct light L40. The direct light L40 is focused and imaged at a position, where the mask for structured detection 61 is disposed, by the imaging lens 56. Direct light L41 that has been transmitted through the mask for structured detection 61 is detected by the photodetector 71. Since the direct light L41 (the bright field light) that is detected by the photodetector 71 is detected by the configuration of the structured detection via the mask for structured detection 61, image information obtained through bright field observation of the shape of the observation object is included.

### Third Embodiment

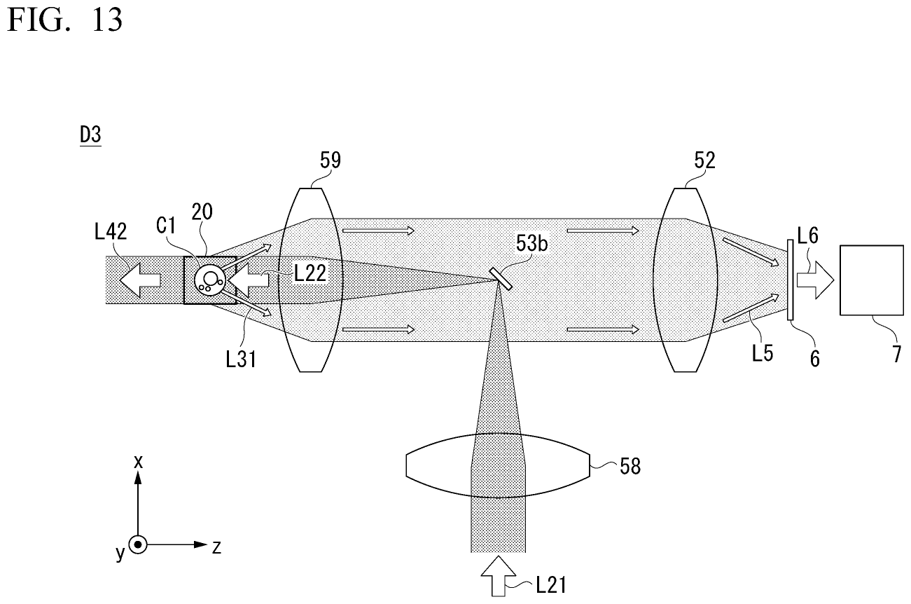

FIG. 13 is a view showing an example of a configuration D3 for performing the structured detection according to the present embodiment. The configuration D3 is a configuration for detecting the BSC through the structured detection in the infinite correction system.

The same constituent elements as those in each embodiment described above are designated by the same reference signs, and descriptions of the same constituent elements and operations may be omitted.

The illumination optical system 4 includes an irradiation lens 58, a mirror 53b, and an irradiation detection lens 59. The imaging optical system 5 includes the irradiation detection lens 59, the mirror 53b, and an imaging lens 52. In the configuration D3, the configuration of the illumination optical system 4 and the configuration of the imaging optical system 5 have some configurations in common (the mirror 53b and the irradiation detection lens 59).

The irradiation lens 58 focuses illumination light L21 onto a position where the mirror 53b is provided. The mirror 53b reflects the illumination light L21 focused by the irradiation lens 58 toward the flow path 20 as illumination light L22. The reflected illumination light L22 is focused by the irradiation detection lens 59 and is irradiated onto the irradiation position of the flow path 20. The shape of the illumination light L22 has a wide width in the length direction of the flow path 20, similarly to the illumination light L2 of each embodiment described above.

The illumination light L22 irradiated from the illumination optical system 4 is irradiated to the cell C1 passing through the irradiation position of the flow path 20. The scattered light is emitted from the cell C1 irradiated with the illumination light L22. Of the scattered light, the BSC that is scattered in a direction opposite to the irradiation direction of the illumination light L22 is input to the irradiation detection lens 59 as scattered light L31. Furthermore, a component of the illumination light L22 irradiated to the cell C1 which has been transmitted through the cell C1 propagates as the direct light L42.

The scattered light L31 that has passed through the irradiation detection lens 59 is input to the imaging lens 52 as an infinite parallel light flux. The scattered light L31 that has been input to the imaging lens 52 is imaged as the scattered light L5 at the position where the mask for structured detection 6 is disposed. The scattered light L6, which is the BSC that has been transmitted through the mask for structured detection 6, is detected by the photodetector 7.

### Fourth Embodiment

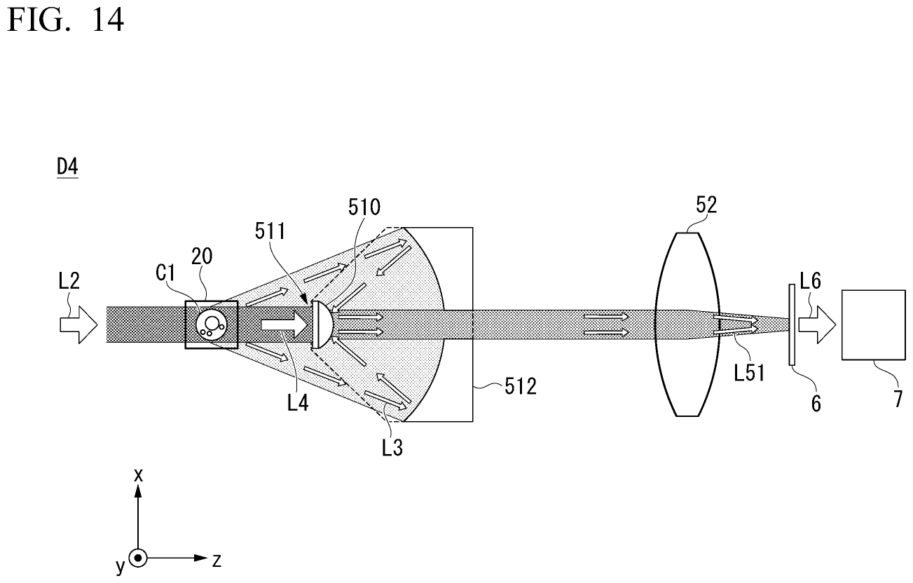

FIG. 14 is a view showing an example of a configuration D4 for performing the structured detection according to the present embodiment. The configuration D4 is a configuration for detecting the FSC through the structured detection using a reflective objective lens in the infinite correction system.

The same constituent elements as those in each embodiment described above are designated by the same reference signs, and descriptions of the same constituent elements and operations may be omitted.

The imaging optical system 5 includes a convex mirror 510, a reflective objective lens 512, and an imaging lens 52.

The convex mirror 510 is a mirror with a convex shape. The convex mirror 510 has a back surface 511 that blocks light. The convex mirror 510 is disposed such that the back surface 511 faces the side of the flow path 20.

The reflective objective lens 512 focuses incident light using a concave mirror. The reflective objective lens 512 is disposed such that the mirror faces a side of the flow path 20. The reflective objective lens 512 has an opening in the center of the mirror.

The scattered light L3, which is the FSC emitted from the cell C1 when the cell C1 is irradiated with the illumination light L2, is input to the reflective objective lens 512. Furthermore, a component of the illumination light L2 irradiated to the cell C1 which has been transmitted through the cell C1 is input to the convex mirror 510 as the direct light L4 and is blocked by the back surface 511.

The configuration D4 has a configuration similar to the first spatial separation configuration A1 (FIG. 3) in principle as a configuration for spatially separating the propagation path of the direct light L4 and the propagation path of the scattered light L3 from each other. That is, the back surface 511 of the convex mirror 510 functions as a light blocker. In the configuration D4, the back surface 591 does not need to be disposed at a position corresponding to the pupil plane. However, the illumination optical system 4 needs to make the diameter of the illumination light L2 smaller than the size of the back surface 511 when the illumination light L2 is irradiated.

The reflective objective lens 512 reflects the input scattered light L3 toward the flow path 20 using the concave mirror, and focuses the light onto the position where the convex mirror 510 is disposed. The convex mirror 510 reflects the scattered light L3 reflected by the reflective objective lens 512 toward the reflective objective lens 512. The scattered light L3 passes through the opening of the mirror of the reflective objective lens 512 and propagates toward the photodetector 7 as parallel light. The scattered light L3 is focused by the imaging lens 52 and imaged as scattered light 51 at the position where the mask for structured detection 6 is disposed. The scattered light L6, which is the FSC that has been transmitted through the mask for structured detection 6, is detected by the photodetector 7.

In the configuration D4, an example in which the direct light L4 is blocked by the back surface 511 of the convex mirror 510 has been described, but the present invention is not limited to this. For example, a plane mirror may be disposed on the back surface 511 to reflect the direct light L4, thereby detecting the direct light L4 at the same time as the scattered light L3 (a configuration of the bright field observation).

In each embodiment described above, either the finite correction system or the infinite correction system may be used. The embodiment having a configuration of the finite correction system may be changed to a configuration of the infinite correction system by changing the configuration of the optical system. The embodiment having a configuration of the infinite correction system may be changed to a configuration of the finite correction system by changing the configuration of the optical system.

Further, in each embodiment described above, except for the third embodiment, an example in which the FSC is detected as the scattered light L3 through the structured detection has been described, but the present invention is not limited to this. The configurations of each embodiment may be changed to detect one or more of the FSC, the BSC, and the SSC through the structured detection.

Further, in each embodiment described above, except for the second embodiment, an example in which only the scattered light is detected through the structured detection has been described, but the present invention is not limited to this. By changing the configuration of each embodiment, the scattered light may be detected through the structured detection and at the same time the FSC that is detected by the flow cytometer of the related art or the direct light may be detected (the bright field light detection). Furthermore, by changing the configuration of each embodiment, the scattered light can be detected through the structured detection and at the same time the BSC and the SSC that are detected by the flow cytometer of the related art and the fluorescence that is emitted by a measurement object can also be detected simultaneously. In this case, the configuration of each embodiment may be configured to detect the BSC, the SSC, the fluorescence, or the bright field light through the structured detection, similarly to the FSC that is detected at the same time.

Furthermore, in each embodiment described above, an example in which the first spatial separation configuration A1 is used as the configuration for spatially separating the propagation path of the direct light L4 and the propagation path of the scattered light L3 from each other by the illumination optical system 4 and the imaging optical system 5 has been described, but the present invention is not limited to this. Any one configuration of the first spatial separation configuration A2, the first spatial separation configuration A3, the first spatial separation configuration A4, and the second spatial separation configuration B1 that have been described as other examples of the configuration for spatially separating the direct light and the scattered light from each other in the first embodiment may be used.

Further, in the first spatial separation configuration that spatially separates the direct light and the scattered light from each other, the method of blocking the direct light L4 is not limited to the method of blocking the direct light L4 exemplified in the first spatial separation configuration A1. As the method of blocking the direct light L4, methods such as absorption, reflection, refraction, and diffraction of light may be used.

### Outline of Each Embodiment

As described above, the flow cytometer 1 according to the present embodiment includes the microfluidic device 2, the light source 3, the illumination optical system 4, the mask for structured detection 6, the imaging optical system 5, and the photodetector 7.

The microfluidic device 2 includes the flow path 20 through which the observation object (the cell C1 in the present embodiment) can flow together with a fluid.

The light source 3 irradiates illumination light L1 toward the observation object (the cell C1 in the present embodiment) flowing through the flow path 20.

The illumination optical system 4 shapes the illumination light L1 irradiated by the light source 3 into the illumination light L2 of which the length in the length direction of the flow path 20 is equal to or greater than the length in the width direction length of the flow path 20 at the irradiation position of the flow path 20 and irradiates the illumination light L2.

The mask for structured detection 6 has the binary pattern of the transmitting portions which transmit light and the blocking portions which block light.

The imaging optical system 5 images the scattered light L3 emitted from the observation object (the cell C1 in the present embodiment) on the mask for structured detection 6 by irradiation of the illumination light L2 shaped by the illumination optical system 4.

The photodetector 7 detects the scattered light L6 transmitted through the transmitting portions of the mask for structured detection 6.

With this configuration, in the flow cytometer 1 according to the present embodiment, the scattered light from the observation object (the cell C1 in the present embodiment) moving in the flow path 20 is detected by the photodetector 7 via the transmitting portions of the mask for structured detection 6.

In addition, in the flow cytometer 1 according to the present embodiment, the propagation path of the illumination light L2 shaped by the illumination optical system 4 and the propagation path of the scattered light L3 emitted from the observation object (the cell C1 in the present embodiment) until the scattered light L3 is detected by the photodetector 7 are spatially separated from each other by the illumination optical system 4 and the imaging optical system 5.

Furthermore, the flow cytometer 1 according to the present embodiment shapes the illumination light L1 into the illumination light L2 of which the length in the length direction of the flow path 20 is equal to or greater than the length in the width direction of the flow path 20, irradiates the observation object with the illumination light L2, and detects the scattered light emitted from the observation object by the photodetector 7 via the mask for structured detection 6. For this reason, higher resolution information derived from the shape of the observation object than information derived from the shape of the observation object acquired in the flow cytometer of the related art can be acquired from only the scattered light by the configuration of the structured detection. The configuration of the structured detection involves a configuration in which the mask for structured detection 6 is provided at a position between a flow path 20 and the photodetector 7 on an optical path from the light source 3 to the photodetector 7 in the GC technology as described above. In the flow cytometer 1 according to the present embodiment, the scattered light emitted from the observation object (the cell C1 in the present embodiment) moving in the flow path 20 is detected by due to the configuration of the structured detection via the transmitting portions of the mask for structured detection 6.

The illumination optical system 4 may shape the illumination light L1 irradiated by the light source 3 into the illumination light L2 of which the ratio of the length in the length direction of the flow path 20 to the length in the width direction of the flow path 20 is greater than 1/10 at the irradiation position of the flow path 20 and may irradiate the shaped illumination light. With this configuration as well, higher resolution information derived from the shape of the observation object than information derived from the shape of the observation object acquired in the flow cytometer of the related art can be acquired from only the scattered light by the configuration of the structured detection.

In the above, one embodiment of this invention has been described in detail with reference to the drawings, but the specific configuration is not limited to that described above, and various design changes and the like can be made without departing from the gist of this invention.

### REFERENCE SIGNS LIST

1 Flow cytometer
2 Microfluidic device
20 Flow path
3 Light source
4 Illumination optical system
6 Mask for structured detection
5 Imaging optical system
7 Photodetector
C1 Cell
L1, L2 Illumination light
L3, L6 Scattered light

1. A flow cytometer comprising:
a microfluidic device that includes a flow path through which an observation object is allowed to flow together with a fluid;
a light source that irradiates illumination light toward the observation object flowing through the flow path;
an illumination optical system that shapes the illumination light irradiated by the light source into illumination light of which a length in a length direction of the flow path is equal to or greater than a length in a width direction of the flow path at an irradiation position of the flow path and irradiates the shaped illumination light;
a mask for structured detection that has a binary pattern of transmitting portions which transmit light and blocking portions which block light;
an imaging optical system that images scattered light emitted from the observation object on the mask for structured detection by irradiation of the illumination light shaped by the illumination optical system; and
a photodetector that detects the scattered light transmitted through the transmitting portions of the mask for structured detection,
wherein a propagation path of direct light, which has been transmitted through the observation object, of the illumination light shaped by the illumination optical system and a propagation path of the scattered light emitted from the observation object until the scattered light is detected by the photodetector are spatially separated from each other by the illumination optical system and the imaging optical system.

2. A flow cytometer comprising:
a microfluidic device that includes a flow path through which an observation object is allowed to flow together with a fluid;
a light source that irradiates illumination light toward the observation object flowing through the flow path;
an illumination optical system that shapes the illumination light irradiated by the light source into illumination light of which a ratio of a length in a length direction of the flow path to a length in a width direction of the flow path is greater than 1/10 at an irradiation position of the flow path and irradiates the shaped illumination light;
a mask for structured detection that has a binary pattern of transmitting portions which transmit light and blocking portions which block light;
an imaging optical system that images scattered light emitted from the observation object on the mask for structured detection by irradiation of the illumination light shaped by the illumination optical system; and
a photodetector that detects the scattered light transmitted through the transmitting portions of the mask for structured detection,
wherein a propagation path of direct light, which has been transmitted through the observation object, of the illumination light shaped by the illumination optical system and a propagation path of the scattered light emitted from the observation object until the scattered light is detected by the photodetector are spatially separated from each other by the illumination optical system and the imaging optical system.

3. The flow cytometer according to claim 1, wherein a lower limit value of the length of the illumination light shaped by the illumination optical system in the length direction of the flow path is 30 micrometers or more, and an upper limit value of the length of the illumination light shaped by the illumination optical system in the length direction of the flow path is 2000 micrometers or less.

4. The flow cytometer according to claim 3, wherein the lower limit value of the length of the illumination light shaped by the illumination optical system in the length direction of the flow path is 50 micrometers or more.

5. The flow cytometer according to claim 3, wherein the upper limit value of the length of the illumination light shaped by the illumination optical system in the length direction of the flow path is 1000 micrometers or less.

6. The flow cytometer according to claim 1, wherein an upper limit value of the length of the illumination light shaped by the illumination optical system in the width direction of the flow path is equal to or less than a width of the flow path.

7. The flow cytometer according to claim 1, wherein a lower limit value of the length of the illumination light shaped by the illumination optical system in the width direction of the flow path is equal to or greater than a degree of positional deviation of a flow line of the observation object flowing through the flow path in the width direction of the flow path.

8. The flow cytometer according to claim 1, wherein the mask for structured detection is set such that a size of a region in which the binary pattern is disposed is 300 μm or less in a width direction and 1500 μm or less in a flow direction on an object plane, and the binary pattern is formed of a plurality of pixels each having a circular shape with a radius of 10 μm or less or a rectangular shape with a side of 10 μm or less on the object plane.

9. The flow cytometer according to claim 1,
wherein the imaging optical system further includes a light blocker disposed between the flow path and the mask for structured detection to block light, and
wherein the propagation path of the direct light, which has been transmitted through the observation object, of the illumination light shaped by the illumination optical system and the propagation path of the scattered light emitted from the observation object until the scattered light is detected by the photodetector are spatially separated from each other by the light blocker blocking the direct light.

10. The flow cytometer according to claim 9, wherein the light blocker is disposed at one or more positions where the direct light is most narrowed by at least one of the illumination optical system and the imaging optical system.

11. The flow cytometer according to claim 1, wherein the illumination optical system shapes the illumination light such that a direction of the propagation path of the direct light, which has been transmitted through the observation object, of the illumination light to be shaped is different from a direction of the propagation path of the scattered light emitted from the observation object until the scattered light is detected by the photodetector.

12. The flow cytometer according to claim 1, wherein a region in which the binary pattern is disposed in the mask for structured detection is smaller than a region in which the illumination light shaped by the illumination optical system is irradiated on an imaging plane of the imaging optical system.

13. The flow cytometer according to claim 2, wherein a lower limit value of the length of the illumination light shaped by the illumination optical system in the length direction of the flow path is 30 micrometers or more, and an upper limit value of the length of the illumination light shaped by the illumination optical system in the length direction of the flow path is 2000 micrometers or less.

14. The flow cytometer according to claim 2, wherein an upper limit value of the length of the illumination light shaped by the illumination optical system in the width direction of the flow path is equal to or less than a width of the flow path.

15. The flow cytometer according to claim 2, wherein a lower limit value of the length of the illumination light shaped by the illumination optical system in the width direction of the flow path is equal to or greater than a degree of positional deviation of a flow line of the observation object flowing through the flow path in the width direction of the flow path.

16. The flow cytometer according to claim 2, wherein the mask for structured detection is set such that a size of a region in which the binary pattern is disposed is 300 μm or less in a width direction and 1500 μm or less in a flow direction on an object plane, and the binary pattern is formed of a plurality of pixels each having a circular shape with a radius of 10 μm or less or a rectangular shape with a side of 10 μm or less on the object plane.

17. The flow cytometer according to claim 2,
wherein the imaging optical system further includes a light blocker disposed between the flow path and the mask for structured detection to block light, and
wherein the propagation path of the direct light, which has been transmitted through the observation object, of the illumination light shaped by the illumination optical system and the propagation path of the scattered light emitted from the observation object until the scattered light is detected by the photodetector are spatially separated from each other by the light blocker blocking the direct light.

18. The flow cytometer according to claim 2, wherein the illumination optical system shapes the illumination light such that a direction of the propagation path of the direct light, which has been transmitted through the observation object, of the illumination light to be shaped is different from a direction of the propagation path of the scattered light emitted from the observation object until the scattered light is detected by the photodetector.

19. The flow cytometer according to claim 2, wherein a region in which the binary pattern is disposed in the mask for structured detection is smaller than a region in which the illumination light shaped by the illumination optical system is irradiated on an imaging plane of the imaging optical system.
